(19) United States
(12) Patent Application Publication
(10) Pub. No.: US 2012/0225715 A1
(43) Pub. Date: Sep. 6, 2012

(54) GAME SYSTEM AND STORAGE MEDIUM

(75) Inventor: Takao YAMAMOTO, Minato-ku (JP)

(73) Assignee: KONAMI DIGITAL ENTERTAINMENT CO., LTD., Tokyo (JP)

(21) Appl. No.: 13/408,167

(22) Filed: Feb. 29, 2012

(30) Foreign Application Priority Data
Mar. 4, 2011 (JP) 2011-047548

(51) Int. Cl. A63F 13/00

(52) U.S. Cl. 463/30

(57) ABSTRACT

A game machine is provided with a monitor, a touch panel and a detecting device which detects a change of a relative position of the game machine. The game machine controls a display position of a determination line based on a detecting result of the detecting device, determines a moving route to be defined by linking a position where a object appears and a arrival position each other, determines the remaining distance from coordinates of a position of the object to the arrival position based on the moving route and determines a velocity of the object based on the remaining distance and time to the arrival time corresponding to the object.

### CROSS REFERENCE TO RELATED APPLICATION

This application claims priority to Japanese Patent Application No. 2011-047548, filed Mar. 4, 2011, the disclosure of which is hereby incorporated by reference in its entirety.

### TECHNICAL FIELD

The present invention relates to a game system which indicates predetermined operations in series to the player and the like.

### BACKGROUND ART

There is a game machine of which operating device is operated in rhythm to music (for example, refer to the patent literature 1). In this game machine, a play of the player is evaluated in accordance with the operation timings by operating the operating portion in rhythm to music when an operation indicator which indicates operation time within the game area moves to a predetermined operation position in a predetermined route. Patent Literature 1:JP-A-2000-155543.

### SUMMARY OF INVENTION

### Technical Problem

In the portable electronic device having a sensor which detects the relative amount of positional change such as the acceleration sensor, it is possible to control the image displayed on the display screen based on the change of relative position of this electronic device. If we apply the above-mentioned game to this portable electronic device, it is necessary to modify the route and the operation position of the operation indicator by modifying the game area based on the amount of positional change. It is necessary to realize the playing feeling without feeling discomfort according to the game area change.

Thus, the present invention aims to provide a game system and the storage medium capable of realizing the playing feeling without discomfort and getting new operating feeling when the game area changes.

### Solution to Problem

The game system of the present invention is a game system comprising: a display device which displays a game screen; an operating device which accepts operations of a player; a detecting device which detects a change of a relative position detected through the operating device; a sequence data storage device which stores sequence data in which appearance time when an operation indicator appears from an indicator generating portion in a game area displayed on the game screen, arrival time when the operation indicator is made to arrive to an operation reference portion and arrival ratio to identify an arrival position where the operation indicator arrives in the operation reference portion at the arrival time are described; an operation reference portion display control device which controls a display position of the operation reference portion based on a detecting result of the detecting device; an arrival coordinate calculating device which calculates coordinates of the arrival position by which a ratio of each length at the time when the operation reference portion is separated by the arrival position accords with the arrival ratio; a route decision device which determines a moving route to be defined by linking a position where the operation indicator appears and the arrival position each other; a distance decision device which determines a remaining distance from coordinates of a position of the operation indicator to the arrival position based on the moving route; and a velocity decision device which determines a velocity of the operation indicator based on a distance determined by the distance decision device and time to the arrival time corresponding to the operation indicator.

According to the game system of the present invention, in the game area of the game screen, the operation indicator is displayed so as to appear from the indicator generating portion, move along the predetermined route and arrive at the arrival position of the operation reference portion. The position of the operation reference portion which is displayed in the game area is determined based on the detecting result of the detecting device and this position is changed by the operation of the player. On the other hand, the moving route of the operation indicator is determined by linking the position where the operation indicator appears in the indicator generating portion and the arrival position. The coordinates of the operation indicator and the remaining distance from the position of the operation indicator to the arrival position are calculated. The remaining time is calculated based on the current time and the arrival time. The distance which the operation indicator moves along the moving route is calculated based on the obtained distance and time. Accordingly, if the game screen turns around according to the change of the relative position of the operating device, the operation reference portion in the game area is controlled in accordance with the displacement. The moving route and the velocity of the operation indicator are recalculated and the operation indicator arrives at the arrival position at the arrival time with varying the moving route and the velocity. Therefore, it is possible to realize the playing feeling without discomfort and get new operating feeling when the game area changes.

As one aspect of the game system of the present invention, the operation reference portion display control device determines a tilt of a perpendicular line drawn from the operation reference portion to the opposite side of the indicator generating portion based on the detecting result of the detecting device and controls the display position of the operation reference portion in order that a maximum length of the perpendicular line from the operation reference portion to a border line of the game area is maintained constant. According to this, if the game screen turns around according to the change of the relative position of the operating device, the operation reference portion is controlled in accordance with the displacement.

As one aspect of the game system of the present invention, in the sequence data of the sequence data storage device, appearance ratio to identify an appearance position where the operation indicator appears from the indicator generating portion at the appearance time is described; and the game system further comprising an indicator generating portion display control device which controls a display position of the indicator generating portion in order that a maximum length of a perpendicular line drawn from the indicator generating portion to the border line of the game area in the opposite direction of the operation reference portion is maintained constant based on the detecting result of the detecting device; and an appearance coordinate calculating device which calculates coordinates of the appearance position by which a ratio of each length at the time when the indicator generating portion is separated by the appearance position accords with the appearance ratio. According to this, the operation reference portion appears from any position of the indicator generating portion based on the appearance ratio when the size of the indicator generating portion in the game area is changed by the operation of the player. Because the appearance position is changed by the operation indicator, it is possible to enhance the enjoyability of the game and it is possible to enjoy playing without discomfort feeling with respect to the progress of the game when the game area is changed by the operation of the player.

As one aspect of the game system of the present invention, in the sequence data of the sequence data storage device, rebound ratio to identify a rebound point where the operation indicator rebounds from the border line of the game area is further described; and if the rebound ratio is described in the sequence data, the route decision device determines the moving route so as to keep the ratio between a length along the border line from the rebound point to the indicator generating portion and a length along the border line from the rebound point to the operation reference portion the same as the rebound ratio. According to this, the operation indicator which appears from the indicator generating portion arrives in the operation reference portion with rebounding from the border line of the game area. Because the rebound point of the border line is determined according to the rebound ratio, it is possible to enhance the enjoyability of the game and it is possible to enjoy playing without discomfort feeling with respect to the progress of the game when the game area is changed by the operation of the player.

As one aspect of the game system of the present invention, the detecting device detects the tilt of an operating surface of the operating device based on the horizontal direction. According to this, because the display of the game area is changed according to the tilt of the operating device, it is possible to realize new operating feeling.

As one aspect of the game system of the present invention, the operating device is a touch panel overlapped on a surface of the display device and the operation device, the display device and the detecting device are configured in a single housing. According to this, the player can operate the operation indicator which arrives at the operation reference portion with touching the touch panel and change the direction of the housing including the touch panel and the like. Accordingly, it is possible to operate intuitively and enhance the enjoyability of the game.

The storage medium of the present invention is a storage medium storing a computer program for a game system comprising: a display device which displays a game screen; an operating device which accepts operations of a player; a detecting device which detects a change of a relative position detected through the operating device; and a sequence data storage device which stores sequence data in which appearance time when an operation indicator appears from an indicator generating portion in a game area displayed on the game screen, arrival time when the operation indicator is made to arrive to an operation reference portion and arrival ratio to identify an arrival position where the operation indicator arrives in the operation reference portion at the arrival time are described; wherein the computer program is constructed so as to the computer to function as: an operation reference portion display control device which controls a display position of the operation reference portion based on a detecting result of the detecting device; an arrival coordinate calculating device which calculates coordinates of the arrival position by which a ratio of each length at the time when the operation reference portion is separated by the arrival position accords with the arrival ratio; a route decision device which determines a moving route to be defined by linking a position where the operation indicator appears and the arrival position each other; a distance decision device which determines a remaining distance from coordinates of a position of the operation indicator to the arrival position based on the moving route; and a velocity decision device which determines a velocity of the operation indicator based on a distance determined by the distance decision device and time to the arrival time corresponding to the operation indicator.

It is possible to function as a game system of the present invention by executing the program of the present invention on the computer of the game system.

### Advantageous Effects of Invention

As mentioned above, according to the present invention, in the game area of the game screen, the operation indicator is displayed so as to appear from the indicator generating portion, move along the predetermined route and arrive at the arrival position of the operation reference portion. The position of the operation reference portion which is displayed in the game area is determined based on the detecting result of the detecting device and this position is changed by the operation of the player. On the other hand, the moving route of the operation indicator is determined by linking the position where the operation indicator appears in the indicator generating portion and the arrival position. The coordinates of the operation indicator and the remaining distance from the position of the operation indicator to the arrival position are calculated. The remaining time is calculated based on the current time and the arrival time. The distance which the operation indicator moves along the moving route is calculated based on the obtained distance and time. Accordingly, if the game screen turns around according to the change of the relative position of the operating device, the operation reference portion in the game area is controlled in accordance with the displacement. The moving route and the velocity of the operation indicator are recalculated and the operation indicator arrives at the arrival position at the arrival time with varying the moving route and the velocity. Therefore, it is possible to realize the playing feeling without discomfort and to get new operating feeling when the game area changes.

### BRIEF DESCRIPTION OF DRAWINGS

FIG. 1 is a diagrammatic illustration of a game machine to which a game system according to one aspect of the present invention.

FIG. 2 is a functional block diagram of the game machine.

FIG. 3A is a diagram showing an outline of a game area.

FIG. 3B is a diagram showing an outline of the game area.

FIG. 3C is a diagram showing an outline of the game area.

FIG. 4 is a diagram showing one example of a configuration of sequence data.

FIG. 5 is a flowchart showing a sequence processing routine to be executed by a game control portion.

### DESCRIPTION OF EMBODIMENTS

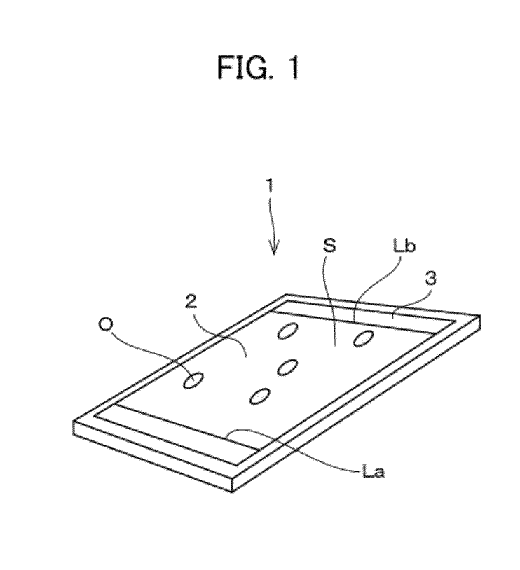

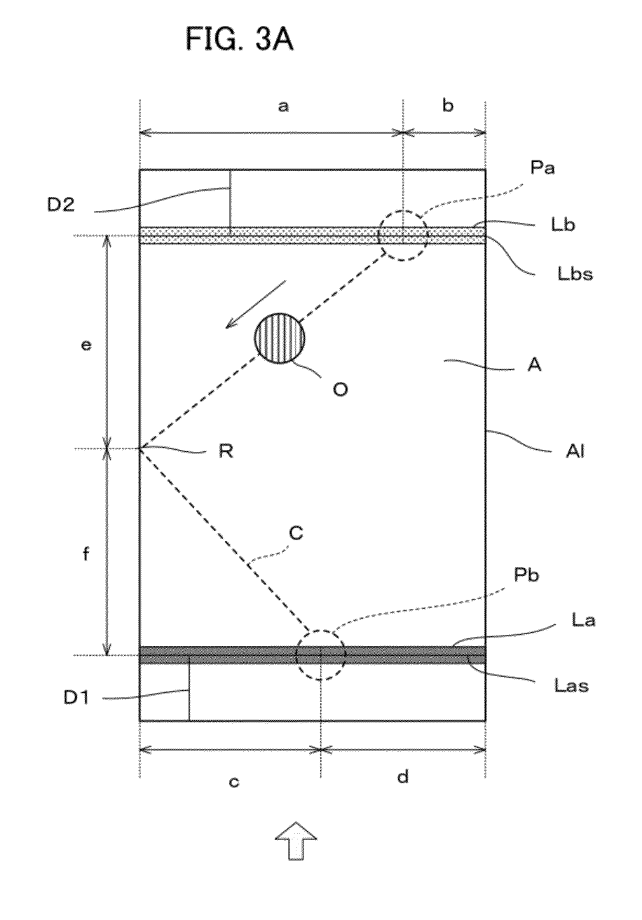

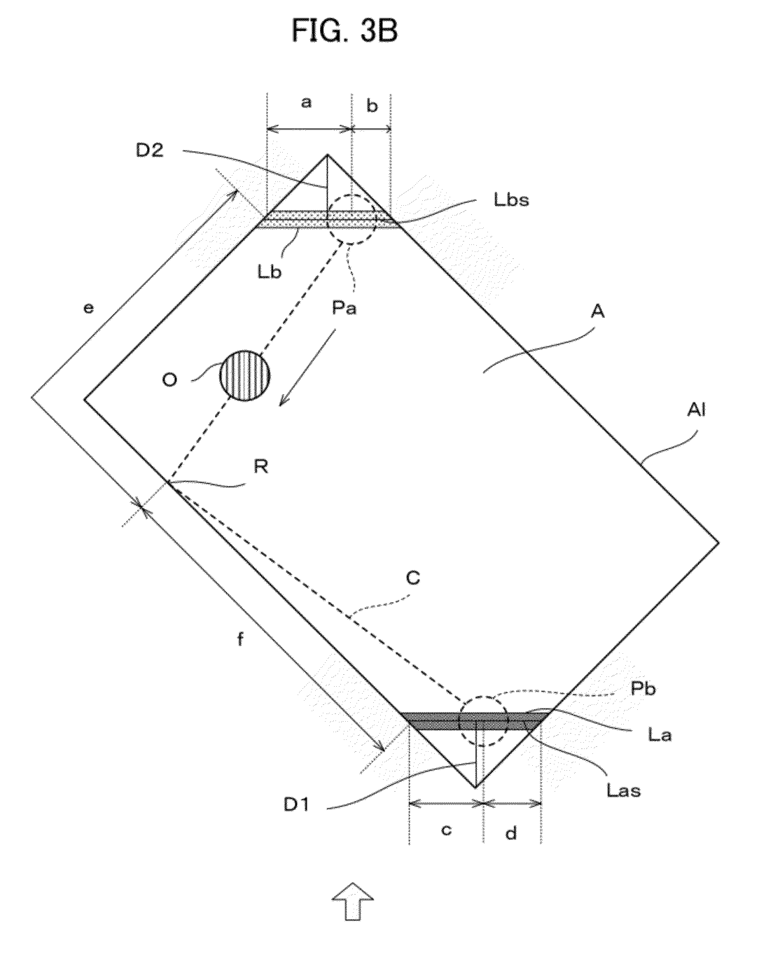

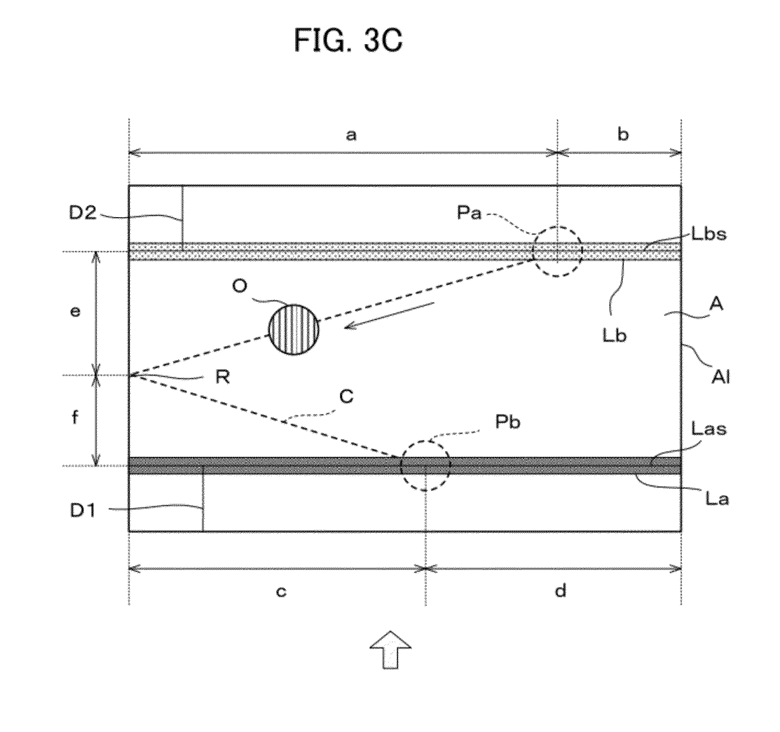

FIG. 1 is a diagrammatic illustration of a game machine to which a game system according to one aspect of the present invention is applied. The game machine 1 is a portable electronic device with a monitor 2. A transparent touch panel 3 is overlapped on a surface of the monitor 2. The touch panel 3 is a conventional input device outputting signals according to touch positions where players P touch with their fingers and the like. The monitor 2 serves as a display device, and the touch panel 3 serves as an operating device. It is possible to apply a cell-phone, a handheld terminal, a tablet computer and the like as the portable electronic device. In the portable electronic device, a detecting device 4 which is detecting change of relative position of the game machine 1 including the touch panel 3 is provided. The detecting device 4 detects the tilt of a game screen S (touch panel 3) of the game machine 1 based on the horizontal direction. It is possible to apply a variety of conventional sensors which detect positional change of the game machine 1 such as an acceleration sensor, a gyroscope, gravity sensor, magnetic sensor and the like as the detecting device 4. It is possible to apply a variety of the known technique for detecting the tilt of the game machine 1. The game machine 1 makes the monitor 2 display the game screen S which appears objects 0 as a operation indicator and a determination line La as an operation reference portion, makes the player P operate the touch panel 3 at the timing when the object O coincides with the determination line La in accordance with the playback of the music (a music piece) selected by the player P. The music game which evaluates the operations of the player P in accordance with the operation timing is executed (refer to FIG. 3). The detail will be described later.

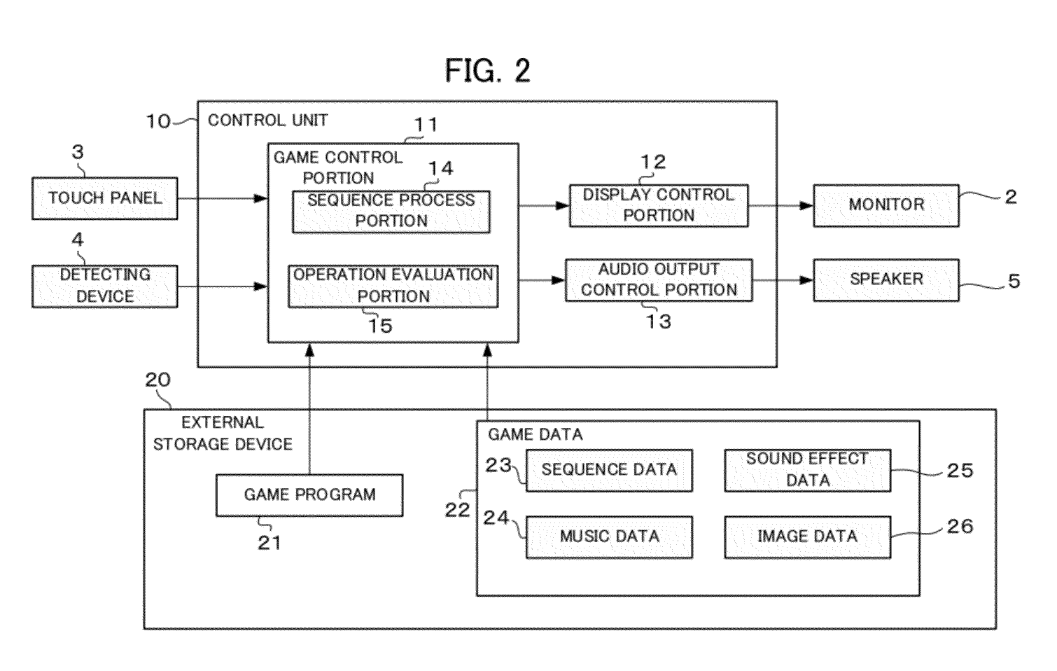

FIG. 2 is a functional block diagram of the game machine 1. The game machine 1 is provided with a control unit 10 as a computer. The control unit 10 is provided with a game control portion 11 and with a display control portion 12 and an audio output control portion 13 which operate in accordance with outputs from the game control portion 11. The game control portion 11 is configured as a unit in which a micro processor and various types of peripherals such as an internal storage device (a ROM and a RAM, for example) and the like necessary for operations of the micro processor are combined. To the game control portion 11, there is connected the touch panel 4 to accept operation by the player and the detecting device 4 to detect change of relative position of the game machine 1. The display control portion 12 displays a predetermined image on the monitor 2 by drawing an image on a frame buffer in accordance with image data provided by the game control portion 11, and issuing a picture signal corresponding to the image to the monitor 2. The audio output control portion 13 makes a speaker 4 of the game machine 1 reproduce predetermined sounds (including music sounds and the like) by generating audio playback signals in accordance with audio playback data which are provided by the game control portion 11, and outputting them to the speaker 4.

Further, to the game control portion 11, an external storage device 20 is connected. In the external storage device 20, there is used a storage medium capable of retaining memory in the absence of supply power, such as a magnetic-storage device and a nonvolatile semiconductor memory device such as an EEPROM. The storage medium of the external storage device 20 may be detachable from the game machine 1.

In the external storage device 20, a game program 21 and game data 22 are stored. The game program 21 is a computer program necessary for an execution of a predetermined music game on the game machine 1. When the game machine 1 starts up, the game control portion 11 executes various types of initializations necessary for operations of the game machine 1 by executing a operation program stored in the internal storage device, and configures environments to execute the music game based on the game program 21 by executing the game program 21 read from the external storage device 20. In the game control portion 11, a sequence process portion 14 and an operation evaluation portion 15 are generated by the execution of the game program 21. The sequence process portion 14 and the operation evaluation portion 15 are logical devices provided by a combination of computer hardware and a computer program. The sequence process portion 14 executes processing such as indications of the operation to the player in accordance with the playback of the music piece and generations of the sound effects in accordance with the operation of the player necessary for the progress of the music game. The operation evaluation portion 15 executes processing such as evaluations of the operation of the player and indications for audio outputs in accordance with the evaluation result. In the game control portion 11, various types of logical devices, other than the logical devices previously mentioned, may be generated by the execution of the game program 21.

In the game data 22, various types of data, which are referred to at the time of the execution of the music game based on the game program 21, are included. For example, sequence data 23, music data 24, sound effect data 25 and image data 26 are included in the game data 22. The sequence data 23 is data which defines the operation and the like to indicate to the player. At least a piece of the sequence data 23 is prepared for a piece of the music data. Many different types of the sequence data 23 which changes a level of difficulty and the like may be prepared for a music piece. The music data 24 is data necessary for a reproduced output of a music piece for a game from the speaker 4. In FIG. 2, one type of the music data 24 is shown, in actuality, it is possible for the player to select the music piece from a number of music pieces for playing. In the game data 22, a number of the music data 24 are stored with information to discern each piece. The sound effect data 25 is data that associate many different types of sound effects to be issued from the speaker 4 in accordance with the operation of the player with a unique code respectively. The sound effects include various types of sounds such as instruments and the like. The image data 26 is data for displaying a background image on the game screen S, various types of objects O, an icon and the like on the monitor 2.

Next, an outline of the music game executed in the game machine 1 will be described. FIG. 3A shows an outline of a game area A. Outside the game area A of the game screen S on the monitor 2, a game information display portion displaying information necessary for the progress of the game such as score which is not shown in FIG. 3A is displayed. The game information display portion turns the display around based on a detection result of the detecting device 4. The game information display portion is controlled according to the tilt of the game machine 1 so as to put the display in the right direction for the player. The term “put the display in the right direction” is the situation in which the display is controlled based on the detection result of the detecting device 4. For example, if the game machine 1 is tilted by 90 degrees in the left direction, character information is displayed without tilting in the relative position to the player by displaying the game information display portion tilted by 90 degrees in the right direction. Additionally, the game information display portion may be displayed in the game area A. At the beginning of the game, in the game area A, the determination line La and an appearance line Lb in which the object O appears are displayed. After the game starts, the object O appears in a predetermined appearance position Pa on the appearance line Lb at the predetermined appearance time, moves along a predetermined route C and arrives at a predetermined arrival position Pb on the determination line La at the predetermined arrival time (refer to FIG. 3A). The position of the object O and the ratio described below are determined based on the reference line Las, Lbs as the basis for each line La and Lb with respect to the determination line La and the appearance line Lb. The operation timing of the player is evaluated by touching the object O on the determination line La. The difference between the time when the player touches the touch panel 3 and the time when the object O coincides with the determination line La is calculated for the evaluation of the operation timing. The operation of the player is evaluated based on this difference. The smaller the difference is, the more positively the player's operation is evaluated.

When the player tilts the game machine 1 to the left as shown in FIG. 3B, the detecting device 4 detects the tilt and the display control portion 12 varies the position of the determination line La and the appearance line Lb of the game area A in accordance with the displacement. The arrow located in the lower side of FIG. 3A to 3C indicates the direction of the player. If the player tilts or rotates the game machine 1, each line La and Lb is displayed in order that the maximum length D1 and D2 from a border line A1 of the game area A to each line La and Lb of the perpendicular line drawn from each line La and Lb to the opposite side of the other line Lb and La is maintained constant. If the player rotates the game machine 1, the relative position of each line La and Lb to the player is maintained during the progress of the game. If the game machine 1 tilts, the display of each line La and Lb is controlled in accordance with the amount of the displacement so as not to vary the relative position to the player. If the player rotates the game machine 1, the velocity of the object O is changed by change of the shape of the game area A and change of the route of the object O in accordance with the rotation of the game machine 1. It is possible to enhance the enjoyability of the game and give the player new operating feeling when the route and the velocity of the object O change.

When the player tilts the game machine further as shown in FIG. 3C, the game area A turns sideways. Even when the game area changes as shown in FIG. 3A to 3C, the appearance position Pa and the arrival position Pb are determined so as to keep the ratio between the length a and b of the appearance line Lb and between the length c and d of the determination line La the same as that at the time when each line Lb and La is separated by each position Pa and Pb. With respect to a rebound point R, the ratio between the length d from the rebound point R on the border line A1 of the game area A to the appearance line Lb along the border line A1 and the length e from the same rebound point R to the arrival line La along the border line A1 is kept even when the game area A is varied.

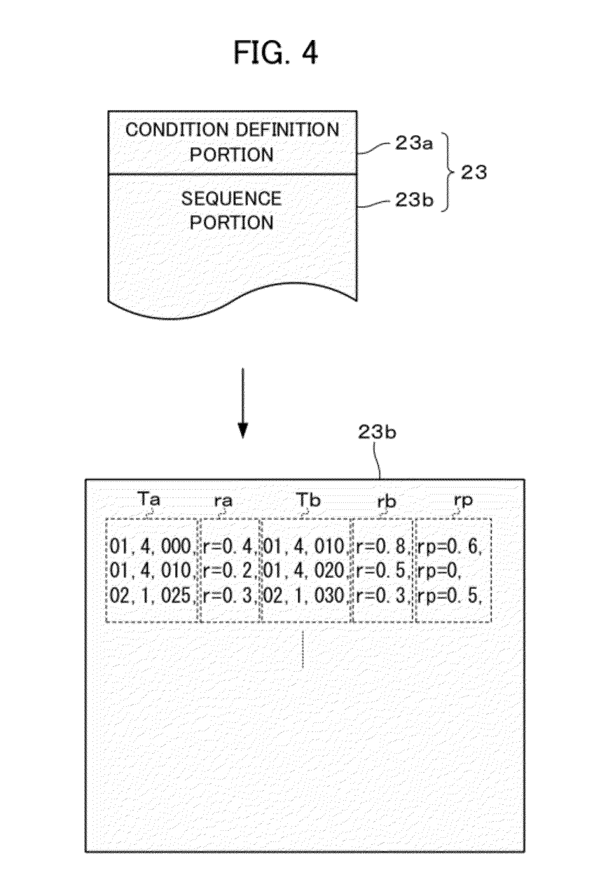

Next, further details about the sequence data 23 will be described in reference to FIG. 4. As shown in FIG. 4, the sequence data 23 includes in a condition definition portion 23a and a sequence portion 23b. In the condition definition portion 23a, information to specify a execution condition of the game which differs from one music piece to another such as the tempo of the music (BPM, for example), information to specify the sound effects when the player P operates the touch panel 4 and information to specify the correspondence relation between the above difference of the operation and the evaluation is described.

On the other hand, in the sequence portion 23b, an appearance ratio to identify the appearance time when the object O appears on the appearance line Lb of the game area A and the appearance position Pa where the object O appears on the appearance line Lb of the game area A and an arrival ratio to identify the arrival time and the arrival position Pb for the player to touch the appearing object O during the playback of the music piece are described corresponding to each object O. And if the rebound point R is on the route C of the object O, the rebound ratio to identify the rebound point R is described correspondingly. In the sequence portion 23b, information to determine whether the rebound point R is located on the left side or the right side of the game screen S may be included. Or whether the rebound point R is located on the left side or the right side of the game screen S may be determined randomly. The appearance position Pa, the arrival position Pb and the position of the rebound point R are shown based on the above ratio.

As a part of the sequence portion 23b is shown in FIG. 4 for example, the sequence portion 23b is configured as set of plural records where the appearance time Ta, the appearance ratio ra, the arrival time Tb, the arrival ratio rb and the rebound ratio rp corresponding to each object O are described. In the appearance time Ta and the arrival time Tb of each record, bar number on the music piece, the number of beat and the time in the beat which are delimited by a comma are described respectively. The time in the beat is elapsed time since the top of a beat and expressed as number from the top of the beat to divide time of a beat into n equal parts. For example, if n=100, the second bar first beat and the time when quarter passed from the top of the beat are specified as appearance timing, it is described as “02, 1, 025”.

In the case of FIG. 4, the appearance time Ta and the operation time Tb are specified in order that the object O that appears at the appearance position Pa on the appearance line Lb on the top of the first bar forth beat (000) and moves along the route C coincides with the arrival position Pb on the determination line La at the time elapsing from the top of the first bar forth beat (000) by the time corresponding to “010”. The appearance position Pa and the arrival position Pb are determined according to the each ratio ra and rb. That is, each length a and b of the appearance line Lb and each length c and d of the determination line La are calculated according to each length ra and rb. And the position of the rebound point R is calculated according to the rebound ratio rp. In FIG. 4, the head of the sequence data 23 is only provided with the condition definition portion 23a, a condition setting portion (not shown) which has information such as information specifying the tempo on the music piece, as with the condition definition portion 23a, and information specifying the sound effect which is generated when the player P operates the touch panel 3 may be included in appropriate location in the middle of the sequence portion 23b. It is possible to execute the processing such as change of the tempo on the music piece and change of assigned sound effect by including such condition setting information in the sequence portion 23b.

Next, processing of the game control portion 11 when the music game is executed in the game machine 1 will be described. The game control portion 11 executes initial settings necessary for the execution of the music game by reading the game program 21 and then stands by for the indications by the player P to start the game. Such indication includes the operation to identify data for use in the game such as selections of the music piece played on the game or the level of difficulty. Acceptance of these indications may follow the same procedure as the conventional music game and the like.

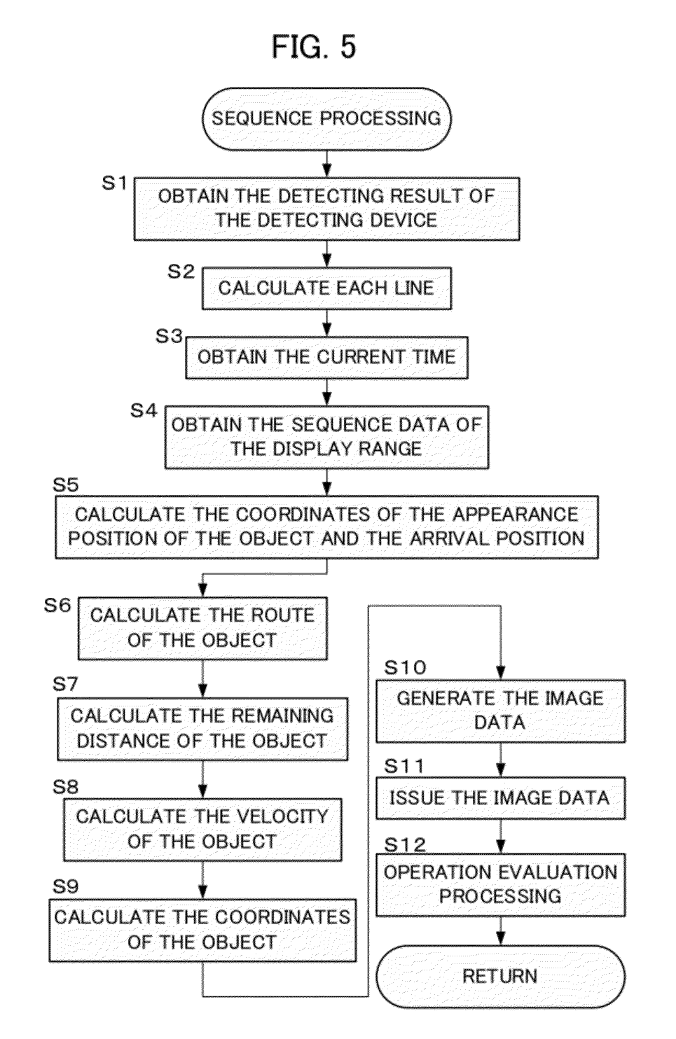

When the game's beginning is indicated, the game control portion 11 starts to play the music from the speaker 5 by reading the music data corresponding to the music selected by the player and outputting the music data at the audio output control portion 13. The game control portion 11 displays the game area A on the monitor 3 by generating and outputting the image data necessary for drawing of the game area A to the display control portion 12 with reference to the image data by reading the sequence data 23 corresponding to the selection of the player P in synchronization with the playback of the music piece. During the execution of the music game, the game control portion 11 repeatedly executes a sequence processing routine shown in FIG. 5 at predetermined intervals as the process necessary for the display of the game area A and the like.

When the sequence processing routine shown in FIG. 5 is executed, the sequence processing portion 14 of the game control portion 11 obtains the detecting result from the detecting device 4 in the first step S1. If the game machine 1 is tilted to the horizontal plane of the game screen S by the operation of the player, the detecting device 4 detects the tilt by using, for example, the triaxial accelerometer detecting acceleration in three directions. In the next step S2, the sequence processing portion 14 calculates the coordinates necessary for the display of the determination line La and the appearance line Lb on the game area A based on the detecting result. With respect to the decision of the determination line La and the appearance line Lb, each line La and Lb is determined in order that the maximum length D1 and D2 from a border line A1 to each line La and Lb of the perpendicular line drawn from the determination line La and the appearance Line Lb to the opposite side of the other line Lb and La is maintained constant. The relative tilt of the perpendicular line is determined based on the detecting result of the detecting device 4. Thus the display position of the determination line La and the appearance line Lb are controlled as shown in FIG. 3A to 3C.

Next, the sequence processing portion 14 obtains the current time on the music piece in the step S3. For example, timer is started with an internal clock in the game control portion 11 on the basis of the point of playback starting time of the music piece and the current time is obtained from the value of the internal clock. In the next step S4, the sequence processing portion 14 obtains the operation time Ta and the arrival time Tb which exists in the duration corresponding to a display range of the game area A and the appearance ratio ra, the arrival ratio rb and the rebound ratio rp necessary for the calculation of the coordinates of the object O from the sequence data 23. As an example of the display range, a time range corresponding to two bars of the music piece from the current time to the future is set.

In the next step S5, the sequence processing portion 14 calculates each coordinate of the appearance position Pa and the arrival position Pb of the object O according to the sequence data 23 obtained in the step S2. The coordinates of the appearance position Pa and the arrival position Pb are calculated based on the appearance ratio ra and the arrival ratio rb, and the whole length of the appearance line Lb and the determination line La calculated in the step S2. Specifically, each length a and b of the appearance line Lb and each length c and d of the determination line La are calculated based on each ratio ra and rb and each coordinate is identified. If the rebound ratio rp is described in the sequence data 23, the coordinates of the rebound point R are calculated based on the rebound ratio rp and the whole length of the line connecting the intersection point of the border line A1 of the game area A and the determination line La with the intersection point of the border line A1 and the appearance line Lb along the border line A1 including the rebound point R. The whole length of the line may be calculated based on the detecting result of the detecting device 4. Specifically, the coordinates are identified by calculating each length e and f on the border line A1 based on the rebound ratio rp.

In the next step S6, the sequence processing portion 14 calculates the route C of the object O. The route C of the object O is determined by connecting the appearance coordinates and the arrival coordinates obtained in the step S5 as the starting point and the ending point by a straight line. If the route C of the object O includes the rebound point R, the route C may be determined so as to go through the coordinates of the rebound point R obtained in the step S5. The route C is not limited to the straight line. The route C may be a line with certain rules for example a curve. In the following step S7, the sequence processing portion 14 calculates the remaining distance from the current position of the object O to the arrival position Pb. The coordinates of the current position obtained by the last sequence processing are used as the coordinates of the current position. The remaining distance is obtained according to the route C and the current coordinates obtained in the step S6. In the next step S8, the sequence processing portion 14 calculates the velocity of the object O based on the remaining distance obtained in the step S7 and the arrival time Tb. In the following step S9, the sequence processing portion 14 calculates the coordinates of the current position of the object O based on the route C of the object O obtained in the step S6 and the velocity of the object O obtained in the step S8.

In the next step S10, the sequence processing portion 14 generates the image data necessary for drawing the game area A based on the coordinates of each line La and Lb calculated by the step S2 and the coordinates of the object O calculated by the step S9. Specifically, the image data suitable for displaying is generated in order that each line La and Lb and the object O is arranged at the calculated coordinates. The image of the each line La and Lb and the object O may be obtained from the image data in the game data 22. In the following step S11, the sequence processing portion 14 issues the image data to the display control portion 12. This makes the monitor 3 show the game area A. Then, in the step S12, the sequence processing portion 14 makes the operation evaluation portion 15 execute the evaluation processing of the operation timings of the player at the operation time obtained in the step S4. As described above, the difference between the time when the player touches the touch panel 3 and the time when the object O coincides with the determination line La is calculated for the evaluation of the operation timing. The operation of the player is evaluated based on this difference. The smaller the difference is, the more positively the player's operation is evaluated. On the other hand, if the operation timing is off, the player's operation is evaluated negatively. If the player does not operate or mistake, the player's operation is evaluated as the failure determination. The processing with regard to the operation evaluation in the step S12 may follow the same as the conventional music game and the like. The sequence processing portion 14 quits the sequence processing routine after finishing the processing of the step S12.

According to the above processing, if the detecting device 4 detects the displacement caused by tilting the game machine 1 or the like, the sequence processing portion 14 calculates the coordinates of the determination line La and the appearance line Lb to display the game area A corresponding to the detecting result (step S1 and S2). And the sequence processing portion 14 obtains the coordinates of the object O by calculating the moving direction and the velocity of the object O displayed on the game area A (step S5 to S9). If the game screen S tilts according to the change of the relative position of the game machine 1, the display of the determination line La and the appearance line Lb of the game area A is controlled based on the tilt. The route and velocity of the object O are recalculated and the object O arrives in the arrival position Pb at the arrival time with varying the route and the velocity. Therefore, it is possible to realize the playing feeling without discomfort and get new operating feeling when the game area A changes.

In the above embodiment, the external storage device 20 of the game machine 1 serves as the sequence data storage device. The sequence processing portion 14 of the control unit 10 serves as the indicator generating potion display control device and the operation reference portion display control device by executing the step S2 of the sequence processing routine in FIG. 5. The sequence processing portion 14 serves as the appearance coordinates calculating device and the arrival coordinate calculating device by executing the step S5. The sequence processing portion 14 serves as the route decision device by executing the step S6. The sequence processing portion 14 serves as the distance decision device by executing the step S7. The sequence processing portion 14 serves as the velocity decision device by executing the step S8. In present embodiment, the touch panel 3 and the game machine 1 are configured as a single operating device and the game machine 1 is provided with the detecting device 4 detecting the displacement of the game machine 1. Accordingly, while having the game machine 1 and operating the touch panel 3, the player operates the game by changing the position of the game machine 1, and by tilting and rotating the game machine 1. The game machine 1 including the touch panel 3 serves as the operating device.

The present invention is not limited to the aforementioned embodiment and can be realized in various kinds of embodiments. For example, in this embodiment, it is described that the monitor 2, the touch panel 3 and the detecting device 4 of the game machine 1 are configured in a single housing, it is not limited. For example, the game machine 1 may be provided with the detecting device 4 contained within a controller having a variety of operation buttons. The game area A displayed by a monitor provided in the different housing from the controller may be rotated by operating the operation buttons and changing the relative position of the controller as substitute for the touch operation by the touch panel 3. In this case, the controller serves as the operating device.

Although, in the above embodiment, the coordinates of the rebound point R are calculated based on the rebound ratio rp and the whole length of the line connecting the intersection point of the border line A1 of the game area A and the determination line La with the intersection point of the border line A1 and the appearance line Lb along the border line A1 including the rebound point R, it is not limited to this. For example, the rebound point R may be the intersection point of the border line A1 and the perpendicular line from the reference point to the border line A1 having the rebound point R by calculating the reference point on the perpendicular line based on the whole length of the perpendicular line connecting the determination line La with the appearance line Lb and the rebound ratio rp.

Although, in the above embodiment, the appearance position Pa of the object O on the appearance line Lb may be determined based on the appearance ratio that identifies the appearance position Pa and is described in the sequence data 23, it is not limited to this. For example, the object O may appear at the specified position on the game area A and the appearance position Pa may be fixed in the specified position. In this case, the appearance position Pa may change the position by the player's operation or may not change the position on the game area A by the player's operation (that is, for the player it seems that the appearance position Pa of the object O moves.).

Although, in the above embodiment, the detecting device 4 detects the tilt of a game screen S of the game machine 1 against horizontal direction and controls the display of the determination line La and the like based on this detecting result, it is not limited to this. For example, the detecting device 4 may detect the rotational displacement that occurs when the game machine 1 rotates about the vertical direction to the horizontal plane of the game screen S of the game machine 1. The determination line La may display on the lower side of the game screen S of the game machine 1 and the appearance line Lb may display on the opposite side. The display control of the determination line La and the appearance line Lb may be the same as the above embodiment. For example, while the perpendicular line from the determination line La to the position as the lowest point on the border line A1 of the game area A may keep the length D1 at the time when the game machine 1 is rotated, and the determination line La may be displayed so as to extend to the vertical direction. Additionally, in the above embodiment, the game display and the following progress of the game are changed by changing the shape of the game area A relatively according to the tilt of the game machine 1, it is not limited to this. For example, if the player tilts the game screen S, the determination line La may display on the lower side of the game screen S in the vertical direction and the appearance line Lb may display on the opposite side. If the player rotates the game machine so as to change the upper side of the game screen S to the lower end in the vertical direction, the determination line La may be displayed on the lower end. The display of each line La is changed as the surface of water in the tilted container. It is possible to change the display of the determination line La and the appearance line Lb, the route of the object O and the like variously according to the detecting result of the detecting device 4.

1. A game system comprising:
a display device which displays a game screen;
an operating device which accepts operations of a player;
a detecting device which detects a change of a relative position detected through the operating device;
a sequence data storage device which stores sequence data in which appearance time when an operation indicator appears from an indicator generating portion in a game area displayed on the game screen, arrival time when the operation indicator is made to arrive to an operation reference portion and arrival ratio to identify an arrival position where the operation indicator arrives in the operation reference portion at the arrival time are described;
an operation reference portion display control device which controls a display position of the operation reference portion based on a detecting result of the detecting device;
an arrival coordinate calculating device which calculates coordinates of the arrival position by which a ratio of each length at the time when the operation reference portion is separated by the arrival position accords with the arrival ratio;
a route decision device which determines a moving route to be defined by linking a position where the operation indicator appears and the arrival position each other;
a distance decision device which determines a remaining distance from coordinates of a position of the operation indicator to the arrival position based on the moving route; and
a velocity decision device which determines a velocity of the operation indicator based on a distance determined by the distance decision device and time to the arrival time corresponding to the operation indicator.

2. The game system of claim 1, wherein
the operation reference portion display control device determines a tilt of a perpendicular line drawn from the operation reference portion to the opposite side of the indicator generating portion based on the detecting result of the detecting device and controls the display position of the operation reference portion in order that a maximum length of the perpendicular line from the operation reference portion to a border line of the game area is maintained constant.

3. The game system of claim 1, wherein
in the sequence data of the sequence data storage device, appearance ratio to identify an appearance position where the operation indicator appears from the indicator generating portion at the appearance time is described; and the game system further comprising an indicator generating portion display control device which controls a display position of the indicator generating portion in order that a maximum length of a perpendicular line drawn from the indicator generating portion to the border line of the game area in the opposite direction of the operation reference portion is maintained constant based on the detecting result of the detecting device; and
an appearance coordinate calculating device which calculates coordinates of the appearance position by which a ratio of each length at the time when the indicator generating portion is separated by the appearance position accords with the appearance ratio.

4. The game system of claim 1, wherein
in the sequence data of the sequence data storage device, rebound ratio to identify a rebound point where the operation indicator rebounds from the border line of the game area is further described; and
if the rebound ratio is described in the sequence data, the route decision device determines the moving route so as to keep the ratio between a length along the border line from the rebound point to the indicator generating portion and a length along the border line from the rebound point to the operation reference portion the same as the rebound ratio.

5. The game system of claim 1, wherein
the detecting device detects the tilt of an operating surface of the operating device based on the horizontal direction.

6. The game system of claim 1, wherein
the operating device is a touch panel overlapped on a surface of the display device and the operation device, the display device and the detecting device are configured in a single housing.

7. A storage medium storing a computer program for a game system comprising:
a display device which displays a game screen;
an operating device which accepts operations of a player;
a detecting device which detects a change of a relative position detected through the operating device; and
a sequence data storage device which stores sequence data in which appearance time when an operation indicator appears from an indicator generating portion in a game area displayed on the game screen, arrival time when the operation indicator is made to arrive to an operation reference portion and arrival ratio to identify an arrival position where the operation indicator arrives in the operation reference portion at the arrival time are described; wherein
the computer program is constructed so as to the computer to function as:
an operation reference portion display control device which controls a display position of the operation reference portion based on a detecting result of the detecting device;
an arrival coordinate calculating device which calculates coordinates of the arrival position by which a ratio of each length at the time when the operation reference portion is separated by the arrival position accords with the arrival ratio;
a route decision device which determines a moving route to be defined by linking a position where the operation indicator appears and the arrival position each other;
a distance decision device which determines a remaining distance from coordinates of a position of the operation indicator to the arrival position based on the moving route; and
a velocity decision device which determines a velocity of the operation indicator based on a distance determined by the distance decision device and time to the arrival time corresponding to the operation indicator.

8. The game system of claim 2, wherein
in the sequence data of the sequence data storage device, appearance ratio to identify an appearance position where the operation indicator appears from the indicator generating portion at the appearance time is described; and the game system further comprising
an indicator generating portion display control device which controls a display position of the indicator generating portion in order that a maximum length of a perpendicular line drawn from the indicator generating portion to the border line of the game area in the opposite direction of the operation reference portion is maintained constant based on the detecting result of the detecting device; and
an appearance coordinate calculating device which calculates coordinates of the appearance position by which a ratio of each length at the time when the indicator generating portion is separated by the appearance position accords with the appearance ratio.

9. The game system of claim 2, wherein
in the sequence data of the sequence data storage device, rebound ratio to identify a rebound point where the operation indicator rebounds from the border line of the game area is further described; and
if the rebound ratio is described in the sequence data, the route decision device determines the moving route so as to keep the ratio between a length along the border line from the rebound point to the indicator generating portion and a length along the border line from the rebound point to the operation reference portion the same as the rebound ratio.

10. The game system of claim 2, wherein
the detecting device detects the tilt of an operating surface of the operating device based on the horizontal direction.

11. The game system of claim 2, wherein
the operating device is a touch panel overlapped on a surface of the display device and the operation device, the display device and the detecting device are configured in a single housing.
